(19) United States
(12) Patent Application Publication
(10) Pub. No.: US 2019/0185230 A1
(43) Pub. Date: Jun. 20, 2019

(54) Disc Shaped Device to Prevent Abrasion

(71) Applicant: AUROBINDO PHARMA LIMITED, Hyderabad (IN)

(72) Inventors: Jayant Karajgi, Hyderabad (IN); Sivakumaran Meenakshisunderam, Hyderabad (IN)

(73) Assignee: Aurobindo Pharma Ltd, Hyderabad (IN)

(21) Appl. No.: 16/311,584

(22) PCT Filed: Jun. 21, 2017
(86) PCT No.: PCT/IB2017/053692

§ 371 Date: Dec. 19, 2018

(30) Foreign Application Priority Data
Jun. 21, 2016 (IN) 201641021193

(51) Int. Cl. B65D 51/26

(52) U.S. Cl. CPC B65D 51/26; A61J 1/03

(57) ABSTRACT

Device for immobilizing contents in a container and more particularly device and a method for immobilizing solid dosage forms such as pills, tablets, capsules or other breakable contents in containers are provided.

### FIELD OF THE INVENTION

The invention relates to a device for immobilizing contents in containers and more particularly to a device designed for substantially immobilizing contents such as solid dosage forms in the form of pills, tablets, capsules or other breakable contents in containers. The invention also provides a method for immobilizing solid dosage forms such as pills, tablets, capsules or other breakable contents in containers so as to substantially reduce or prevent abrasion of the contents during handling and transportation.

### BACKGROUND OF THE INVENTION

Content immobilizing devices in containers are known in the state of the art such as cotton wads or sponge/foam pads inserted in the headspace of the container to prevent abrasion of the solid dosage forms such as pill, tablet or capsule during shipment or transit of the pharmaceutical products. Further it is also known in the state of the art to employ springs such as coiled metallic springs that exert a resilient expansive force between the lid and a plunger of flat plat which engages the solid dosage forms at various levels in accordance with the degree of the fullness of the containers.

U.S. Pat. No. 2,091,212 A by Mcneil Laboratories discloses a package comprising cotton or other integral wadding inserted in the top of the container so as to completely fill the space immediately above the said tablets or other contents compacted in said space to an extent immobilizing the said contents thereby preventing damage. This is done by an element attached to the wadding and supported at the mouth of the container in position to be readily grasped by the fingers, whereby when said element is lifted away, the attached wadding is withdrawn from the container.

U.S. Pat. No. 3,010,570 A by Sundstrom et al. discloses an invention wherein the tablets or other small objects are packaged in a rigid or semi rigid container of any design, configuration and construction material and are immobilized therein by a filler consisting of one or of several pieces of a material which is highly compressible by a force which up to a characteristic bottoming point does not increase proportionally with the extent of compression but which has good restitution characteristics.

U.S. Pat. No. 6,398,051 by Owens-Illinois Closure Inc. relates to an integral insert for a container assembly that will take the place of cotton in the container. The container assembly also provides evidence of tampering with the seal of the container. Therefore, in one sealing operation, the manufacturer not only seals the top of the filled container, but also provides space filler which replaces the normal cotton wad. The container is efficient in use, capable of a long operable life, and particularly adapted for the proposed use.

JAYFILLA of Nolato Jaycare Ltd is a device for gently restraining tablets, pills and capsules during transit to minimize abrasion damage and absorb impact energy. It is specifically designed for use with securitainers as an ullage filler and replacement for foam and cotton-wool. The device comprises of a base body and a lid with protruding flanges in circular direction. However such devices are difficult and costly to manufacture particularly because of their shape.

Several drawbacks occur in the prior art devices and methods known to prevent abrasion of contents packed in a container. Cotton wads or sponge/foam pads have minute fibers which can attach to the surface of the oral dosage forms due to static nature during transit. Further, sterility of the cotton can be a point of concern when used in filling the headspace. Even though cotton wads are generally used, there is still a probability of abrasion during transit. Furthermore, many devices like JAYFILLA have replaced the cotton wads in the containers, but still the cost involved in the manufacturing of the devices inevitably increases the cost of the pharmaceutical product. Thus, there is still, need to develop devices which overcome the drawbacks of the prior art as well as are easy to manufacture and, easy to use, and at the same time are cost effective. The inventors of the present invention have endeavored to develop alternative cost effective device to overcome the shortcomings of the prior art.

### SUMMARY OF INVENTION

In one aspect, the present invention relates to a device for immobilizing contents in containers.

In one aspect, the present invention relates to a device designed for substantially immobilizing contents such as solid dosage forms in the form of pills, tablets, capsules or other breakable contents in containers.

In one aspect, the present invention relates to a device for packaging solid dosage forms within a container, said device comprising of a flat circular shaped disk.

In another aspect, the present invention relates to a device comprising of a flat circular shaped disk, which comprises a plurality of flexible resilient petals extending radially outwardly from a periphery of said disk.

In a further aspect, the invention relates to a method for immobilizing solid dosage forms such as pills, tablets, capsules or other breakable contents in containers so as to substantially reduce or prevent abrasion of the contents during handling and transportation.

### BRIEF DESCRIPTION OF THE DRAWINGS

The invention, together with additional objects, features and advantages thereof, will be best understood from the following description, and the accompanying drawings in which:

FIG. 1 is a top plan sectional view of the device;

FIG. 2 is a vertical view bisecting a package in accordance with one presently preferred embodiment of the invention;

### DETAILED DESCRIPTION OF THE INVENTION

The invention will now be described in detail in connection with certain preferred and optional embodiments, so that various aspects thereof may be more fully understood and appreciated.

The term ‘resilient’ in context of the present invention is refers to the disk and the petals of the disk which is able to recoil or spring back into shape after bending, stretching, or being compressed.

In the specification, singular forms, including the singular forms “a,”, “an” and “the”, specifically also encompass the plural referents of the terms to which they refer unless the context clearly dictates otherwise. In addition, as used herein, unless specifically indicated otherwise, the word “or” is used in the “inclusive” sense of “and/or” and not the “exclusive” sense of “either/or”.

As used in this specification, whether in a transitional phrase or in the body of a claim, the terms “comprise(s)” and “comprising” are to be interpreted as having an open-ended meaning. That is, the terms are to be interpreted synonymously with the phrases “having at least” or “including at least”.

The present invention provides a device for packaging solid dosage forms within a container, said device comprising of a flat circular shaped disk.

In an embodiment, the present invention relates to a device which comprises a plurality of flexible resilient petals extending radially outwardly from a periphery of said disk.

In another embodiment, the present invention relates to a device wherein the flexible resilient petals are circumferentially spaced around said disk.

In an embodiment, the outer edges of petals are on a common circle of revolution concentric with the axis of device, and are integrally interconnected by a plurality of intervening frangible webs.

Yet another embodiment relates to a device wherein the device comprises a semi-circular slit in the center of the disk for easy removal of the disc. The device according to the context of the present invention is one-piece molded plastic construction.

In one of the embodiments, the container may additionally comprise of other immobilizing devices known in the state of the art such as cotton wads or sponge/foam pads.

It might be appreciated that person skilled in the art can place additional immobilizing devices in the headspace, below the disc as an additional safety measure to prevent abrasion.

In another embodiment of the present invention, the circular shaped disk is constructed using suitable inert plastic materials selected from a group comprising high density polyethylene (HDPE), low density polyethylene (LDPE), thermoplastic elastomer (TPE) and mixtures thereof.

In an embodiment, the outer diameter of petals is greater than the inner diameter of the container body.

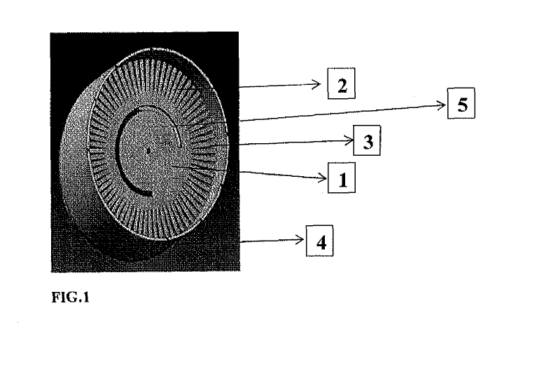

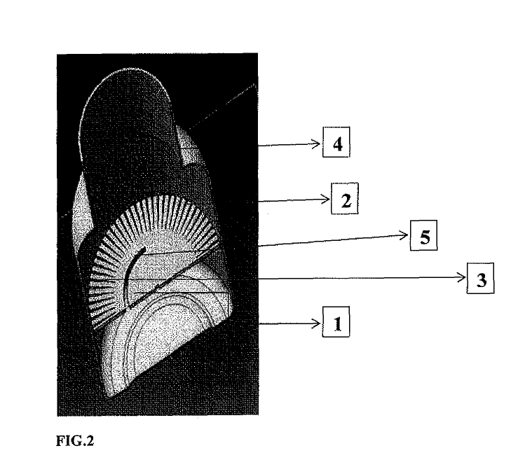

In an embodiment plurality of flexible resilient circumferentially spaced petals (2) extend radially outwardly from the periphery of disk (1). The outer edges of petals (2) are on a common circle of revolution, and are integrally interconnected by a plurality of intervening integral frangible webs (3). Webs (3) help prevent petals (2) from becoming entangled during shipment. In forming the package, container (4)is first filled with tablets through the open mouth of container finish. Semi-circular Slit (5) is then opened and Disk (1) is placed over the tablets wherein Petals (2) flex inwardly and upwardly when pressure is applied. In the particular embodiment illustrated in FIGS. 1-2 the outer diameter of petals (2) is greater than the inner diameter of the container body, so that petals (2) remain partially upwardly flexed and slide along the inside surface of the container body. The tight placement of the disc thus prevents accidental abrasion of the tablets.

1. A disc shaped device for immobilizing contents within a container having a finish with an open mouth, said device comprising: (i) a flat circular shaped disk; (ii) a plurality of circumferentially spaced flexible resilient petals which are extended radially outwardly from a periphery of circular shaped disk; (iii) frangible webs; (iv) a semicircular slit in the centre of the disk; and wherein said petals are integrally interconnected by plurality of intervening integral frangible webs.

2. A device according to claim 1, wherein said device is of one-piece molded plastic construction.

3. A device according to claim 1, wherein the circular shaped disc is constructed or made up of inert plastic material.

4. A device according to claim 3, wherein said inert plastic material is selected from a group comprising High density polyethylene (HDPE), Low density polyethylene (LDPE), Thermoplastic elastomer (TPE) and mixtures thereof.

5. A device according to claim 1, wherein the outer diameter of flexible resilient petals is greater than the inner diameter of the container.

6. A device according to claim 1, wherein said petals are circumferentially spaced around said disk.

7. A device according to claim 1, wherein the semicircular slit is in the centre of the disk for easy removal of the disc.

8. A device according to claim 1, wherein the said disk and petals of the disk are able to recoil into shape after stretching or being compressed.

9. A method for immobilizing contents within a container to prevent abrasion during transit, said method comprising the steps of: (i) preparing the container for filling; (ii) filling the container with the contents to a desired surface level; (iii) placing the disc shaped device over the contents; (iv) storing the container which is filled with the contents; and wherein the said container has a finish with an opening at one end for attaching a closure.

10. The method of immobilizing contents according to claim 9, wherein said contents in the container is selected from a group comprising tablets, capsules, pills, or other breakable contents.
